(19) United States
(12) Patent Application Publication
(10) Pub. No.: US 2010/0321150 A1
(43) Pub. Date: Dec. 23, 2010

(54) SYSTEM AND METHOD FOR GUIDING VISITOR USING SENSOR NETWORK

(76) Inventors: Eun-Ju Lee, Daejon (KR); Jae-Hong Ryu, Daejon (KR); Gwang-Ja Jin, Daejon (KR); Young-Min Kim, Daejon (KR); Bong-Soo Kim, Daejon (KR); Cheol-Sig Pyo, Daejon (KR); Jong-Suck Chae, Daejon (KR)

Correspondence Address: STAAS & HALSEY LLP, SUITE 700, 1201 NEW YORK AVENUE, N.W., WASHINGTON, DC, 20005, US

(21) Appl. No.: 12/446,066

(22) PCT Filed: Oct. 12, 2007
(86) PCT No.: PCT/KR2007/004995

§ 371 Date: Apr. 17, 2009

(30) Foreign Application Priority Data
Oct. 18, 2006 (KR) 10-2006-0101344

(51) Int. Cl. G06F 7/04

(52) U.S. Cl. 340/5.7

(57) ABSTRACT

Provided are a system and method for guiding a visitor using a sensor network. The system includes: an entry approval requesting unit for requesting an entry approval of the visitor to the visitee terminal according to destination information; a route setting unit for setting a route along which the visitor terminal is to move to the destination, based on the destination information of the visitor, according to an entry approval result of the visitee terminal; a location detecting unit for detecting a current location of the visitor terminal based on identification information of the visitor terminal and location information of the sensor node, the identification information and the location information being obtained through the sensor network on the route; and a location confirming unit for confirming if the detected current location of the visitor terminal is out of a preset area.

### TECHNICAL FIELD

The present invention relates to a system and method for guiding a visitor using a sensor network; and, more particularly, to a system and method for guiding a visitor along an origin-to-destination route or a destination-to-origin route using a sensor network established in a building.

This work was supported by the Information Technology (IT) research and development program of the Korean Ministry of Information and Communication (MIC) and/or the Korean Institute for Information Technology Advancement (IITA) [2005-S038-02, “Development of UHF RE-ID and Ubiquitous Networking Technology”].

### BACKGROUND ART

Recently, digital revolution has taken hold in a convergence form all over the families and societies. As one example, a smart home connects information appliances together as an initial stage of a digital convergence. The ultimate purpose of the digital convergence is to establish human-oriented network environments through self-control of information appliances.

Studies on human-oriented network environments have been conducted to expand the network environment from residential environments, e.g., homes, to various working environments, e.g., offices, laboratories, factories and schools., where most of persons spend most time of a day. For example, the smart home is a case where the human-oriented network environments are applied to the residential environments, and a smart building or smart office is a case where the human-oriented network environments are applied to the working environments.

A ubiquitous sensor network (USN) plays an essential role in establishing the human-oriented network. The USN is a network configured to collect a variety of information from various kinds of sensors by using a wireless personal area network (WPAN), and an ad-hoc network.

The smart building is a building that is managed using the USN and can further improve optimization through an advanced environment control and increase the economy and efficiency of building management than typical building management systems.

However, building management systems supporting the concept of the smart building have not been proposed in detail, and most of buildings are operated by the typical building management systems.

Demands for the smart buildings, where the human-oriented network environments are applied to the building management systems, will be considerably increased in the future. In other words, typical buildings need to be equipped with systems that can detect in advance urgent situations, e.g., invasion or fire, by collecting information related to a comfortable environment, efficient use of energy, and safety of structures, thus making it possible to prevent the damages and inform managers or visitors in the urgent situations.

For example, the typical building management systems merely announce urgent situations, such as fire occurrence, to visitors who do not well know locations or routes within the building. Therefore, the visitors may know the fire occurrence, but face dangers when they lose their way or do not find an exit. Therefore, there is a need for methods that guide in-building locations and pathways to persons such as visitors who visit the building for the first time.

In particular, for companies such as IT enterprises, whose fates depend on their essential technology, security of self-developed technologies is important. To this end, high-tech companies manage visitor's entry into the building by using closed-circuit television (CCTV), fingerprint recognition, and a security card. Therefore, there is a need for systems that achieve security management and entry limit by providing the location guidance or route guidance to the visitors.

### DISCLOSURE

### Technical Problem

An embodiment of the present invention is directed to providing a system and method for guiding a visitor along an origin-to-destination route or a destination-to-origin route using a sensor network established in a building.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a system for guiding a visitor using a sensor network, wherein the system is connected to a visitee terminal and communicates with a visitor terminal through the sensor network, the sensor network including sensor nodes having information on in-building locations, a sink node, a gateway, and a middleware, the system including: an entry approval requesting unit for requesting an entry approval of the visitor to the visitee terminal according to destination information provided by the visitor; a route setting unit for setting a route along which the visitor terminal is to move to the destination, based on the destination information of the visitor, according to an entry approval result of the visitee terminal; a location detecting unit for detecting a current location of the visitor terminal based on identification information of the visitor terminal and location information of the sensor node communicating with the visitor terminal, the identification information and the location information being obtained through the sensor network on the route set by the route setting unit; and a location confirming unit for confirming if the detected current location of the visitor terminal is out of a preset area.

In accordance with another aspect of the present invention, there is provided a method for guiding a visitor using a sensor network, wherein the sensor network includes a visitor terminal and a visitee terminal, where an application for a visitor guidance and a location detection is installed, a sensor node having information on in-building locations, a sink node, a gateway, and a middleware, the method including the steps of: a) requesting an entry approval of the visitor to the visitee terminal according to destination information provided by the visitor; b) setting a route along which the visitor terminal is to move up to the destination, based on the destination information of the visitor, according to an entry approval result of the visitee terminal; c) detecting a current location of the visitor terminal based on identification information of the visitor terminal and location information of the sensor node communicating with the visitor terminal on the set route; d) confirming if the detected current location of the visitor terminal is out of a preset area on the set route; e) performing a room entry procedure of the visitor terminal according to a type of a door when the movement of the visitor terminal is completed.

### ADVANTAGEOUS EFFECTS

The system and method in accordance with the embodiments of the present invention can detect the location of the visitor and guide the visitor.

Further, the system and method in accordance with the embodiments of the present invention can guide the visitor to the visitee based on the information on the current location of the visitor detected through the sensor network.

### BRIEF DESCRIPTION OF THE DRAWINGS

FIG. 1 illustrates a system for guiding a visitor using a sensor network in accordance with an embodiment of the present invention.

FIG. 2 is a flowchart describing a method for guiding a visitor along an origin-to-destination route using a sensor network in accordance with an embodiment of the present invention.

FIG. 3 is a flowchart describing a method of guiding a visitor along a destination-to-origin route using a sensor network in accordance with an embodiment of the present invention.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

A system for guiding a visitor using a sensor network in accordance with the embodiments of the present invention guides a visitor from an information desk or entrance (hereinafter, referred to as an origin) to an office (hereinafter, referred to as a destination) of a person the visitor wants to visit. The person the visitor wants to visit will be hereinafter referred to as a “visitee”.

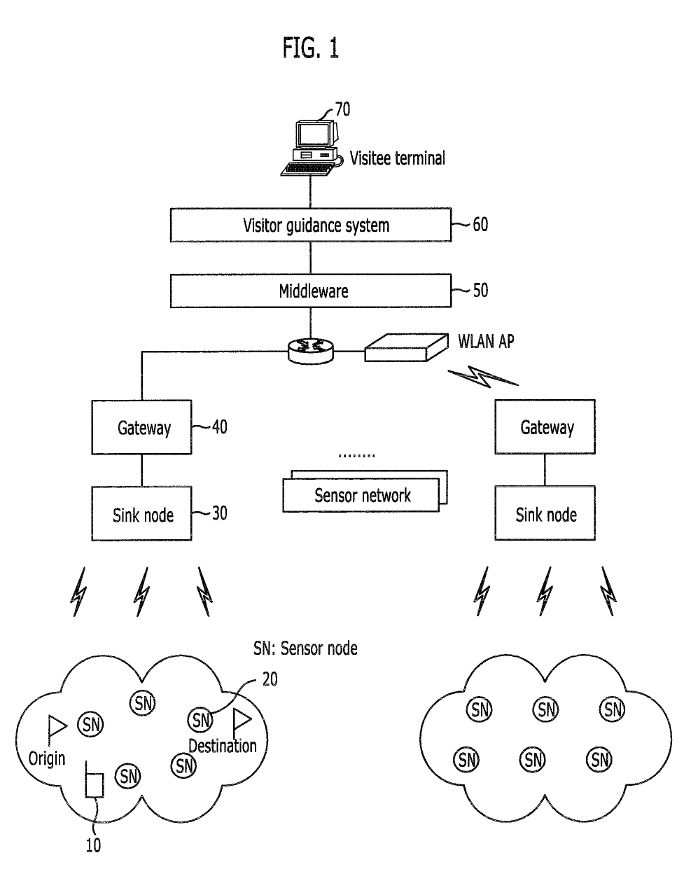

FIG. 1 illustrates a system for guiding a visitor using a sensor network in accordance with an embodiment of the present invention.

Referring to FIG. 1, a system for implementing a visitor guidance service using a sensor network includes a visitor terminal 10, a plurality of sensor nodes 20, a sink node 30, a gateway 40, a middleware 50, a visitor guidance system 60, and a visitee terminal 70.

The visitor terminal 10 is a terminal that provides a visitor guidance service to a visitor. The visitor terminal 10 detects a location of the visitor and guides the visitor to a visiting route, while performing a sensor node function. The visitor terminal 10 may be the visitor's own personal digital assistant (PDA) and portable terminal. The visitor terminal 10 may also be a terminal that is supplied to the visitor in order for the visitor guidance service only on his/her visit.

In order to receive the visitor guidance service, the visitor terminal 10 must download a visitor guidance application having a location recognition algorithm. Using the visitor guidance service, the visitor terminal 10 displays information on the route from an origin, i.e., a current location of the visitor, to a destination, i.e., a current location of the visitee. When the visitor moves from the origin toward the destination, the visitor terminal 10 displays information on the changing location of the visitor on the visiting route. That is, the visitor terminal 10 measures the intensity of signals from sensor nodes 20 fixed within the building and sets a communication path to the sensor node 20 having the greatest signal intensity. The visitor terminal 10 transmits its own identification information to the sensor node 20, so that the visitor guidance system 60 can identify the visitor terminal 10.

In addition, when the visitor deviates from a predefined area, i.e., the origin-to-destination route, the visitor terminal 10 may inform the visitor and the visitor guidance system 60 of the route deviation. In this way, the visitor can reach the destination or the origin along the optimal route without deviation. The visitor guidance system 60 detects the visitor's route deviation, which makes it possible to limit the visitor's entry and maintain the security of the building.

The sensor nodes 20 are fixed within the building to form a sensor network, and perform a wireless communication with the visitor terminal 10. The sensor nodes 20 stores identification information corresponding to information on in-building locations and thus the visitor guidance system 60 can identify the in-building locations based on the identification information stored in the sensor nodes 20. That is, the sensor nodes 20 transmit, to an upper-level network, their own identification information and the identification information of the visitor terminal 10, which is provided while communicating with the visitor terminal 10. In this way, the visitor guidance system 60 can identify a specific location within the building where the visitor terminal 10 is positioned.

In addition, the sensor nodes 20 collect sensing information detected by sensors. Specifically, the sensor nodes 20 detect the visitor's motion through the sensors and transmit information on the visitor's motion to the sink node 30. For example, the sensor nodes 20 may detect whether the visitor enters a room by using a thermal sensor or an infrared sensor.

The sink node 30 transmits event data collected through the visitor terminal 10 or the sensor nodes 20 to an external network linked to the sensor network, and manages the sensor network.

The gateway 40 is linked to the sink node 30 and the middleware 50 and adequately manages data flow. In particular, the gateway 40 links various IP-based networks to the sensor network, allowing mutual access.

The middleware 50 transmits the event data transmitted from the gateway 40 to the visitor guidance system 60. Since the middleware 50 is well known to those skilled in the art, its detailed description will be omitted for conciseness.

The visitor guidance system 60 is driven for visitor guidance and visitor management. In addition, the visitor guidance system 60 stores data necessary for the visitor guidance and the visitor management. Particularly, the visitor guidance system 60 previously stores the location information of the visitee terminal 70.

Furthermore, the visitor guidance system 60 transmits information inputted by the visitor to the visitee terminal 70 and thus the visitee can know that someone visits him or her. The information inputted by the visitor may include a name of the visitee, a purpose of visit, a date of visit, and personal information of the visitor, which will be referred to as “visit detail information.”

When the visitee terminal 70 approves the entry of the visitor, the visitor guidance system 60 checks the previously stored location information of the visitee terminal 70 and provides the visitor terminal 10 with the information on the origin-to-destination route. The visitor guidance system 60 may receive location information changed by the visitee. Since the visitor guidance system 60 provides the visitor terminal 10 with new route information based on the changed location information, the visitee can meet the visitor at a specific location the visitee wants.

The visitor guidance system 60 checks the current location of the visitor terminal 10 in real time and provides the visitor terminal 10 with the information on the current location of the visitor terminal 10. The visitor terminal 10 displays the location of the visitor along a corresponding route in real time.

As mentioned above, the visitor guidance system 60 can check the current location of the visitor terminal 10 within the building based on the identification information of the visitor terminal 10 and the identification information of the sensor node 20.

In addition, when the visitor guidance system 60 receives no information on the current location of the visitee within a predetermined time, it determines that the visitee is absent, and transmits a short message service (SMS) message to a previously registered portable terminal of the visitee, making the visitee know that someone visits him or her. Since the transmission of the SMS message is achieved using a known method, its detailed description will be omitted for conciseness.

Further, the visitor guidance system 60 manages an application for providing the visitor guidance service to the visitor terminal 10, and provides the application to the visitor terminal 10 upon request of the visitor terminal 10.

The visitee terminal 70 interfaces with the visitor guidance system 60 to provide the visitee with a series of processes necessary for the visitor guidance service and transmit a response result of the visitee to the visitor guidance system 60.

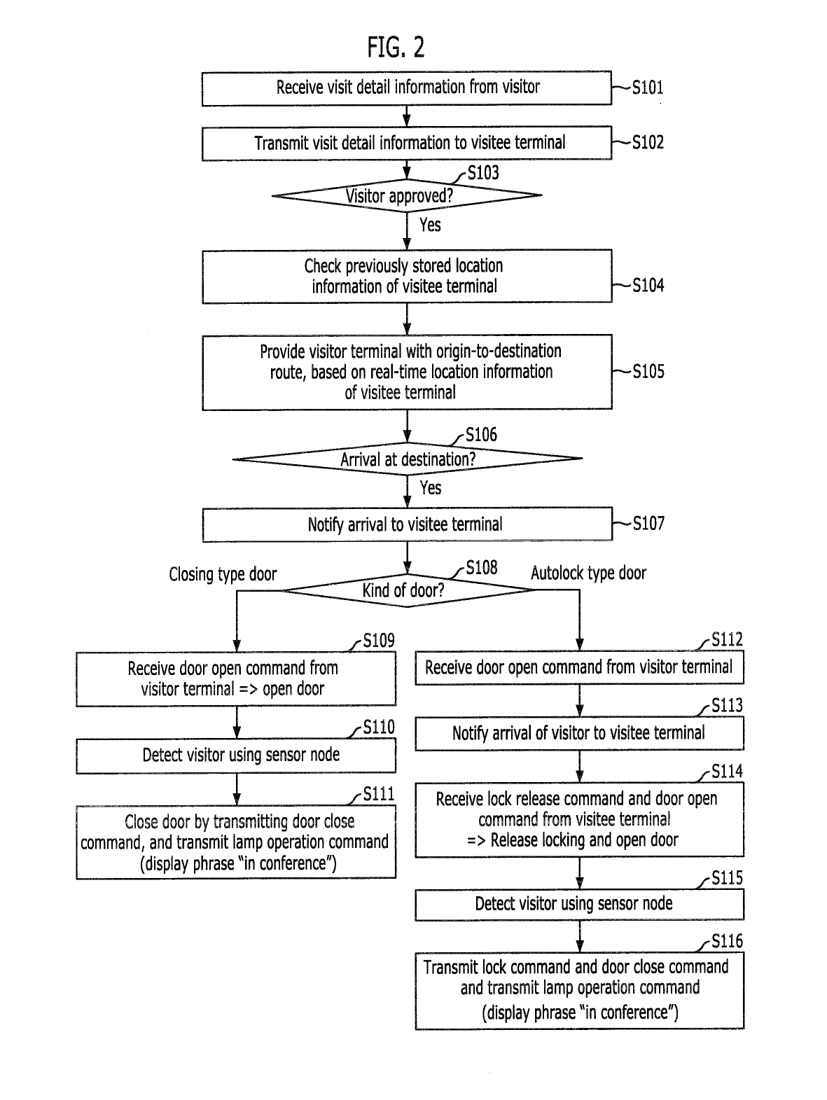

FIG. 2 is a flowchart describing a method for guiding a visitor along an origin-to-destination route by using a sensor network in accordance with an embodiment of the present invention.

Referring to FIG. 2, in steps S101 and S102, when a visitor inputs visit detail information, the visitor guidance system 60 reports that someone visits him or her by transmitting the visit detail information to the visitee terminal 70.

In steps S103 and S104, when the visitor is approved by the visitee terminal 70, the visitor guidance system 60 checks the previously stored location information of the visitee terminal 70.

In step S105, the visitor guidance system 60 provides the visitor terminal 10 with the origin-to-destination route, based on the current location information of the visitee. The visitor guidance system 60 checks the current location of the visitor terminal 10 in real time and provides the visitor terminal 10 with the information on the current information of the visitor terminal 10. Therefore, the visitor terminal 10 can reflect its own location on the origin-to-destination route in real time.

In steps S106 and S107, when the visitor terminal 10 arrives at the destination, the visitor guidance system 60 notifies the arrival at the destination to the visitor terminal 10.

In step S108, before the visitor enters an office, the visitor guidance system 60 determines a kind of a door installed for the purpose of security. In the following description, a closing type door and an autolock type door will be taken as an example. The closing type door is a door in which no autolock system is installed but an opening/closing of the door can be controlled by the visitor guidance system 60. The autolock type door is a door in which an autolock system is installed therein and an opening/closing of the door can be controlled by the visitor guidance system 60. The present invention is not limited to these doors. That is, various kinds of doors may also be applied to the present invention.

In step S109, when the kind of the door is the closing type door and a door open command is transmitted from the visitor terminal 10, the visitor guidance system 60 opens the door in response to the door open command. At this point, when the visitor selects a door open button through the visitor terminal 10, the door open command is transmitted to the visitor guidance system 60 through the sensor network.

In step S110, the visitor guidance system 60 confirms through the sensor network that the visitor enters the office. The visitor guidance system 60 detects the visitor using the sensor nodes 20 previously installed in the office. The sensor nodes 20 may detect the visitor through thermal detection and infrared detection.

In step S111, the visitor guidance system 60 closes the door by transmitting a door close command to the closing type door, and transmits a lamp operation command to a lamp installed in the entrance door. One example of the lamp operation command is to display the phrase “in conference”.

In steps S112 and S113, when the kind of the door is the autolock type door and a door open command is transmitted from the visitor terminal 10, the visitor guidance system 60 notifies the arrival of the visitor to the visitee terminal 70.

In step S114, when a lock release command and a door open command are transmitted from the visitee terminal 70, the visitor guidance system 60 releases the locking of the door and opens the door.

In step S115, the visitor guidance system 60 confirms through the sensor network that the visitor enters the office.

In step S116, the visitor guidance system 60 closes the door by transmitting a door close command to the autolock type door, and locks the door by transmitting a lock command. At this point, the visitor guidance system 60 transmits a lamp operation command to a lamp installed in the entrance door. One example of the lamp operation command is to display the phrase “in conference”.

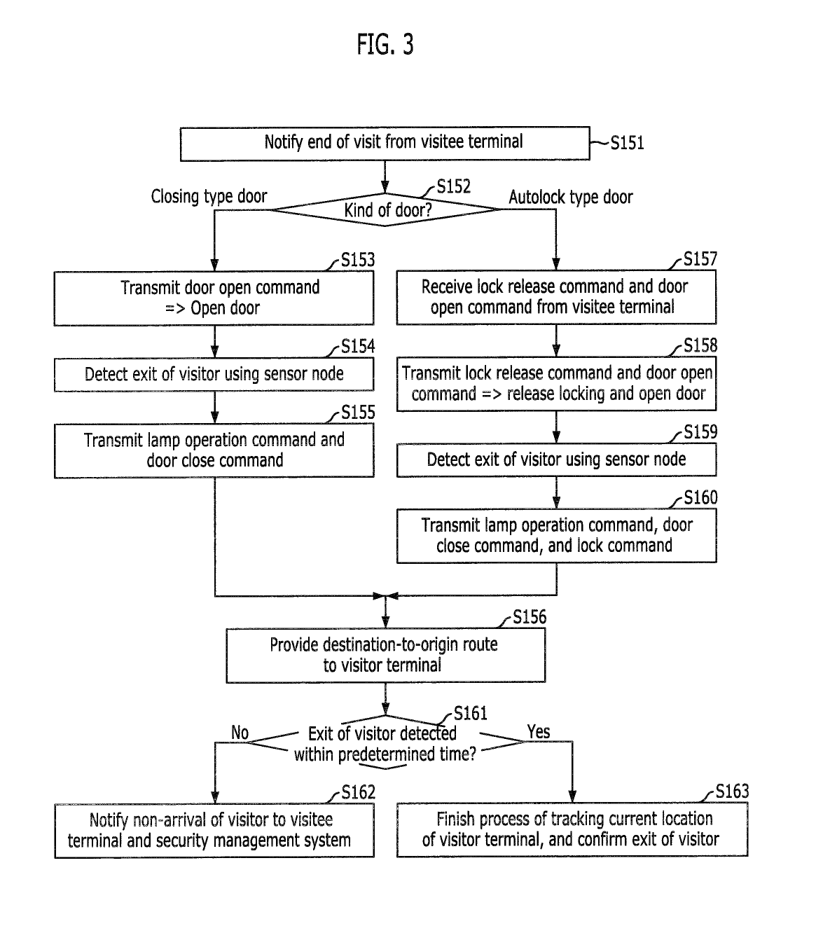

FIG. 3 is a flowchart describing a method for guiding a visitor along a destination-to-origin route by using a sensor network in accordance with an embodiment of the present invention.

Referring to FIG. 3, in steps S151 and S152, when a notification indicating the end of visit is transmitted from the visitee monitor 70, the visitor guidance system 60 guides the visitor according to the kind of the door.

In step S153, when the kind of the door is the closing type door, the visitor guidance system 60 opens the door by transmitting a door open command to the door. In steps S154 and S155, when the exit of the visitor is detected through the sensor nodes 20, the visitor guidance system 60 transmits a lamp operation command to the lamp and a door close command to the door.

In step S156, the visitor guidance system 60 guides the destination-to-origin route to the visitor terminal 10.

In step S157, when the door is the autolock type door, the visitor guidance system 60 receives a lock release command and a door open command from the visitee terminal 70. In step S158, the visitor guidance system 60 unlocks a locking device by transmitting an unlock command to the locking device, and opens the door by transmitting a door open command.

In steps S159 and S160, when the exit of the visitor is detected through the sensor nodes 20, the visitor guidance system 60 transmits a lamp operation command to the lamp, a door close command to the door, and a lock command to the locking device.

In step S156, the visitor guidance system 60 guides the destination-to-origin route to the visitor terminal 10.

In step S161, the visitor guidance system 60 confirms if the exit of the visitor is detected within a predetermined time. In step S162, when the exit of the visitor is not detected within the predetermined time, the visitor guidance system 60 notifies the nonarrival of the visitor to the visitee terminal 70 or a security management system. In step S163, when the exit of the visitor is detected within the predetermined time, the visitor guidance system 60 finishes the process of tracking the location of the visitor terminal 10 and confirms the exit of the visitor.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

The present application contains subject matter related to Korean Patent Application No. 2006-0101344, filed in the Korean Intellectual Property Office on Oct. 18, 2006, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

1. A system for guiding a visitor using a sensor network, wherein the system is connected to a visitee terminal and communicates with a visitor terminal through the sensor network, the sensor network including sensor nodes having information on in-building locations, a sink node, a gateway, and a middleware, the system comprising:
an entry approval requesting unit for requesting an entry approval of the visitor to the visitee terminal according to destination information provided by the visitor;
a route setting unit for setting a route along which the visitor terminal is to move to the destination, based on the destination information of the visitor, according to an entry approval result of the visitee terminal;
a location detecting unit for detecting a current location of the visitor terminal based on identification information of the visitor terminal and location information of the sensor node communicating with the visitor terminal, the identification information and the location information being obtained through the sensor network on the route set by the route setting unit; and
a location confirming unit for confirming if the detected current location of the visitor terminal is out of a preset area.

2. The system of claim 1, where the visitor terminal includes a door controlling unit for controlling a closing/opening of a door installed in the destination.

3. The system of claim 1, further comprising:
a short-message-service (SMS) message transmitting unit for transmitting an SMS message to a previously registered portable terminal of a visitee terminal when the entry approval requesting unit does not receive the entry approval within a predetermined time.

4. The system of claim 1, further comprising:
an application providing unit for providing an application to provide a route from the current location of the visitor terminal to the destination.

5. The system of claim 1, wherein when information on a changed location of the visitee is transmitted from the visitee terminal, the entry approval requesting unit provides the location on the changed location of the visitee as the destination information to the route setting unit.

6. A method for guiding a visitor using a sensor network, wherein the sensor network includes a visitor terminal and a visitee terminal, where an application for a visitor guidance and a location detection is installed, a sensor node having information on in-building locations, a sink node, a gateway, and a middleware, the method comprising:
requesting an entry approval of the visitor to the visitee terminal according to destination information provided by the visitor;
setting a route along which the visitor terminal is to move up to the destination, based on the destination information of the visitor, according to an entry approval result of the visitee terminal;
detecting a current location of the visitor terminal based on identification information of the visitor terminal and location information of the sensor node communicating with the visitor terminal on the set route;
confirming if the detected current location of the visitor terminal is out of a preset area on the set route;
performing a room entry procedure of the visitor terminal according to a type of a door when the movement of the visitor terminal is completed.

7. The method of claim 6, wherein the setting route along which the visitor terminal is to move up to the destination, based on the destination information of the visitor, according to an entry approval result of the visitee terminal, includes:
notifying the presence of the visitor to a previously registered portable terminal of the visitee when the visitee terminal does not give the entry approval within a predetermined time.

8. The method of claim 6, wherein the setting route along which the visitor terminal is to move up to the destination, based on the destination information of the visitor, according to an entry approval result of the visitee terminal, includes:
modifying the location information of the visitee, which is changed by the visitee terminal, into the destination information of the visitor.

9. The method of claim 6, wherein the performing room entry procedure of the visitor terminal according to a type of a door when the movement of the visitor terminal is completed, includes
closing/opening the door in response to a door control command of the visitor terminal.
